(19) United States
(12) Patent Application Publication
(10) Pub. No.: US 2007/0146253 A1
(43) Pub. Date: Jun. 28, 2007

(54) Method and device for brightness stabilization in AMOLED display

(75) Inventor: Yu Chun Tang, Niaosong Hsiang (TW)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: AU Optronics Corporation

(21) Appl. No.: 11/317,493

(22) Filed: Dec. 22, 2005

(51) Int. Cl. G09G 3/30

(52) U.S. Cl. 345/77

(57) ABSTRACT

A driving system is used in an active matrix display device to adjust the data line signal voltage level based on the voltage drop in the power supply so as to maintain the voltage potential between the gate terminal and the source terminal of a driving TFT to a certain level. In particular, when the power supply is a battery and the voltage provided by the battery decreases with time, the brightness of display device would decrease accordingly. The driver system comprises a voltage monitoring device to monitoring the battery voltage drop, a data driver to provide the data line signal voltage level to driving TFT, and a correction module to adjust the data line signal voltage level based on the voltage drop according to the gamma operable range of the display device.

### FIELD OF THE INVENTION

The present invention relates generally to an OLED display and, more particularly, to an active matrix OLED display using an amorphous silicon TFT backplane, low-temperature polysilicon (LTPS) backplane, or the like.

### BACKGROUND OF THE INVENTION

Active matrix organic light emitting diode (AMOLED) displays have been increasingly used in small electronic devices such as mobile phones and PDAs. The attractiveness of AMOLEDs is in their high brightness, compactness, low power consumption, fast response time and a wide viewing angle, as compared to liquid crystal displays (LCDs). Also, an AMOLED display is operative in a wider range of temperatures. However, unlike LCDs, OLEDs are current driven devices and the brightness of the OLEDs is in proportion to the current driven through the OLEDs. As such, the uniformity of the pixel-to-pixel OLED driving current greatly affects the uniformity of a displayed image.

A typical driving circuit for an AMOLED display is shown in FIG. 1. As shown in FIG. 1, a pixel in an AMOLED display comprises at least a control TFT (M1) operatively connected to a data line and a scan line, and a driving TFT (M2). The driving TFT M2 controls the current through the OLED and, therefore, the brightness of the pixel. In particular, the driving TFT is a p-MOS thin-film transistor in backplane made of amorphous silicon. The power supply to the OLED is required to provide a positive voltage Vdd and a negative voltage Vss. Typically Vdd is about 3.3 v and Vss is about −9 v. A Li-battery of 3.7 v can be directly applied to the Vdd end, while a DC/DC converter is used to convert the positive 3.7 v to the negative Vss level. Over time, the voltage on the battery decreases and so does Vdd. The decrease in Vdd also causes the decrease in voltage potential Vgs, which is substantially equal to the difference between Vdd and the data line signal voltage level, Vdata. When the voltage potential Vsg drops below a certain level, the brightness of the OLED decreases significantly.

It is advantageous and desirable to provide a method and device to monitor the drop in the battery voltage and to compensate for the drop in the voltage potential Vsg so as to improve the quality of the displayed image when the battery becomes low.

### SUMMARY OF THE INVENTION

The present invention uses a driving system in an active matrix display device to adjust the data line signal voltage level based on the voltage drop in the power supply so as to maintain the voltage potential between the gate terminal and the source terminal of a driving TFT to a certain level. In particular, when the power supply is a battery and the voltage provided by the battery decreases with time, the brightness of the display device would decrease accordingly. The driver system comprises a voltage monitoring device to monitor the battery voltage drop, a data driver to provide the data line signal voltage level to driving TFT, and a correction module to adjust the data line signal voltage level based on the voltage drop according to the gamma operable range of the display device.

### BRIEF DESCRIPTION OF THE DRAWINGS

FIG. 1 is a circuit diagram showing a prior art power source for use in an AMOLED panel to provide driving power to the OLEDs.

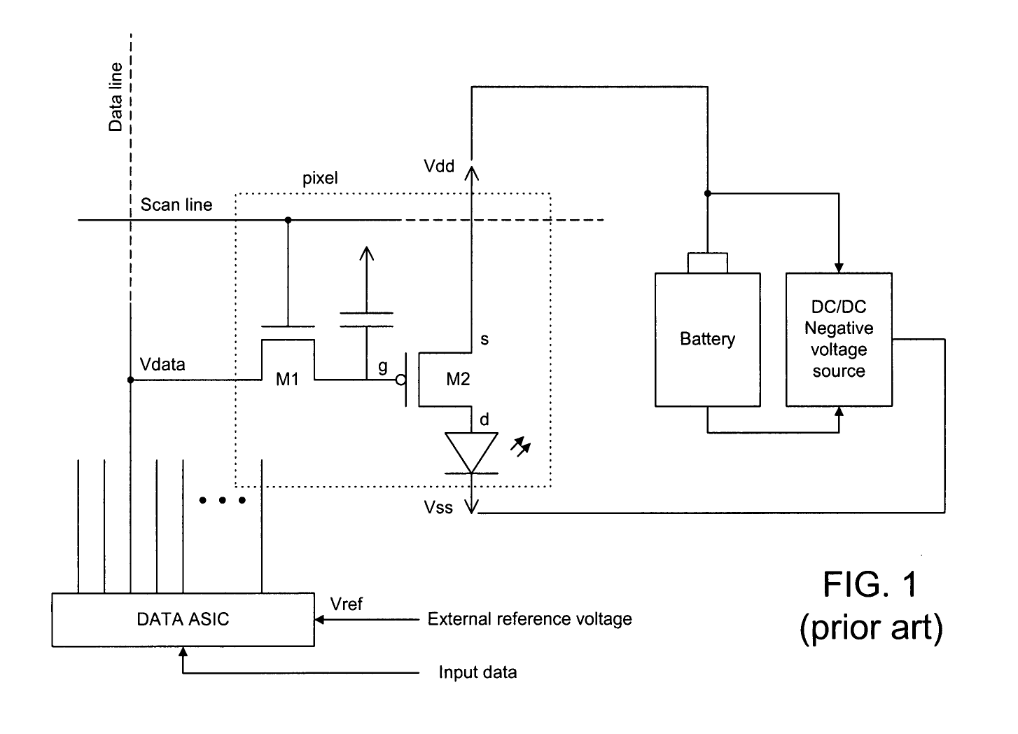

FIG. 2a is a circuit diagram showing the power source for use in an AMOLED panel having a pMOS driver and an nMOS switching device, according to the present invention.

FIG. 2b is a circuit diagram showing the power source for use in an AMOLED panel having an nMOS driver and a pMOS switching device, according to the present invention.

FIG. 2c is a circuit diagram showing the power source for use in an AMOLED panel having an nMOS driver and an nMOS switching device, according to the present invention.

FIG. 2d is a circuit diagram showing the power source for use in an AMOLED panel having a pMOS driver and a pMOS switching device, according to the present invention.

FIG. 3 is a plot showing the relationship between the useful gamma control range and the voltage of the battery.

FIG. 4 is a plot showing the different sections of a gamma operable range.

FIG. 5 shows a binary representation being used to provide data swing to a data ASIC.

### DETAILED DESCRIPTION OF THE INVENTION

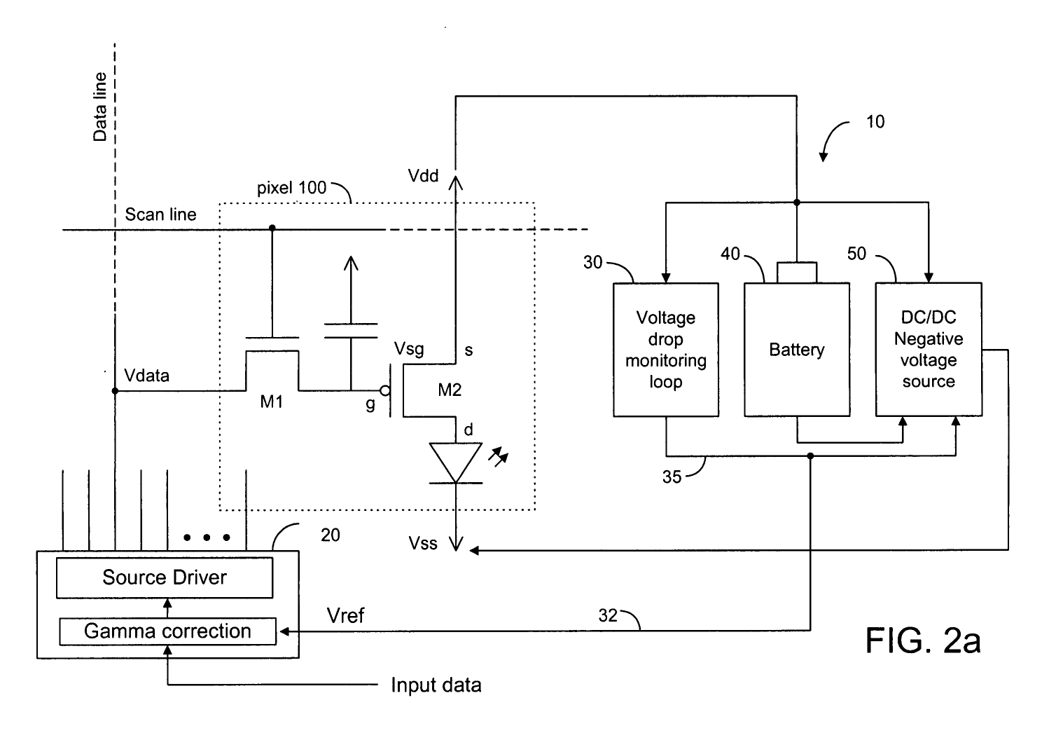

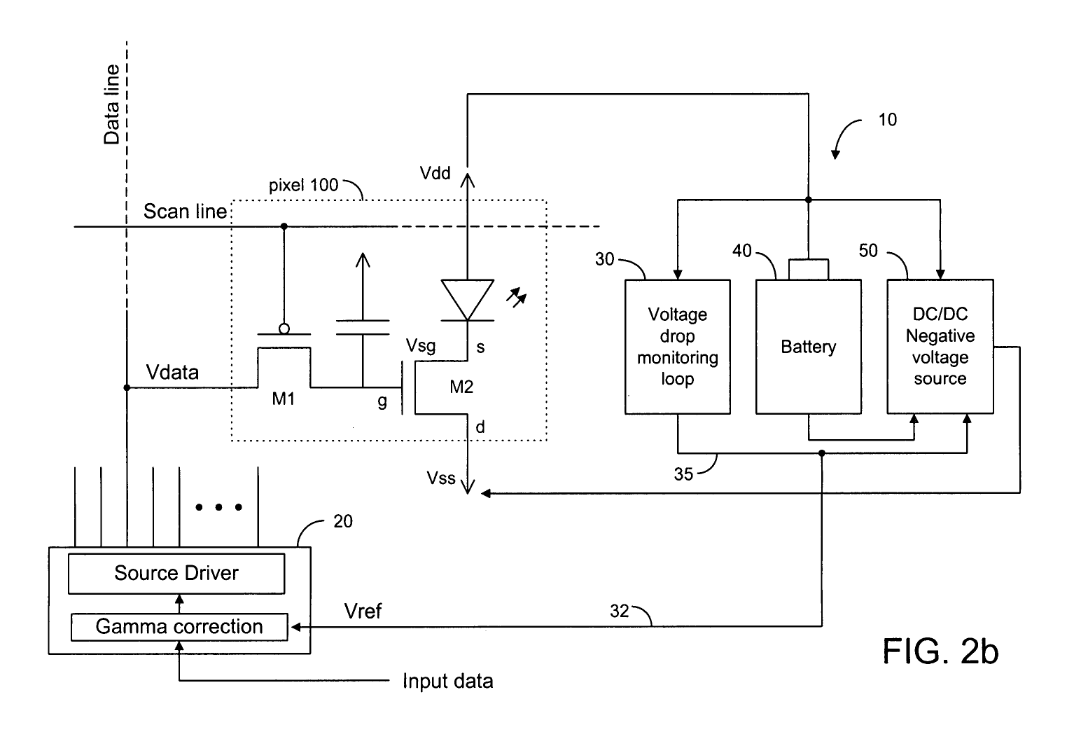

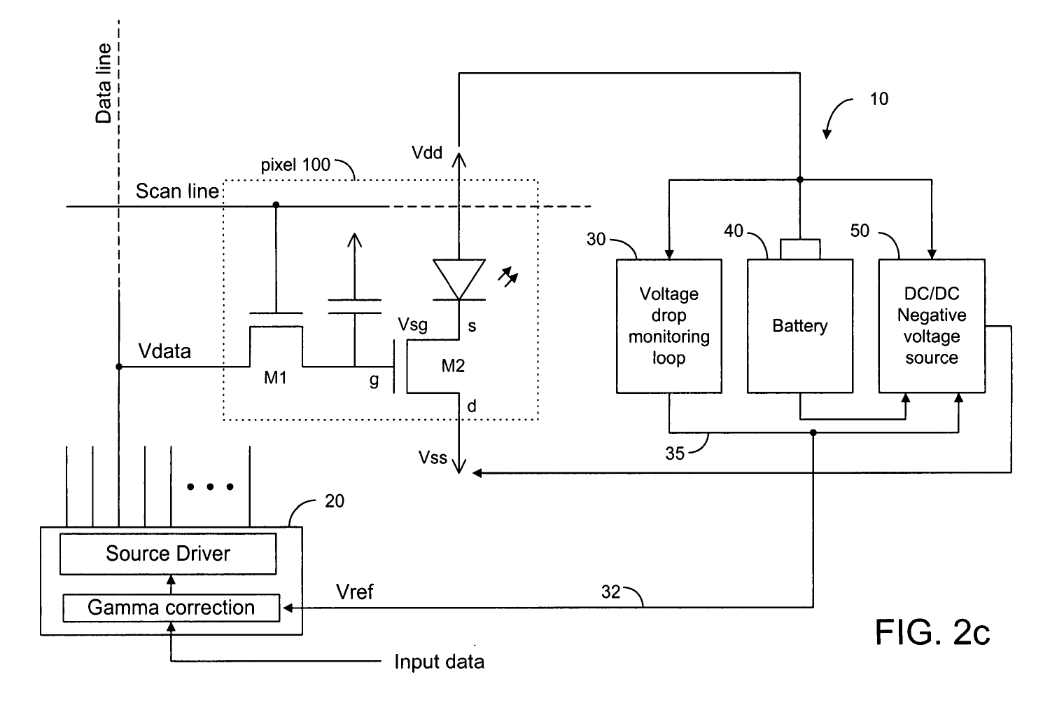

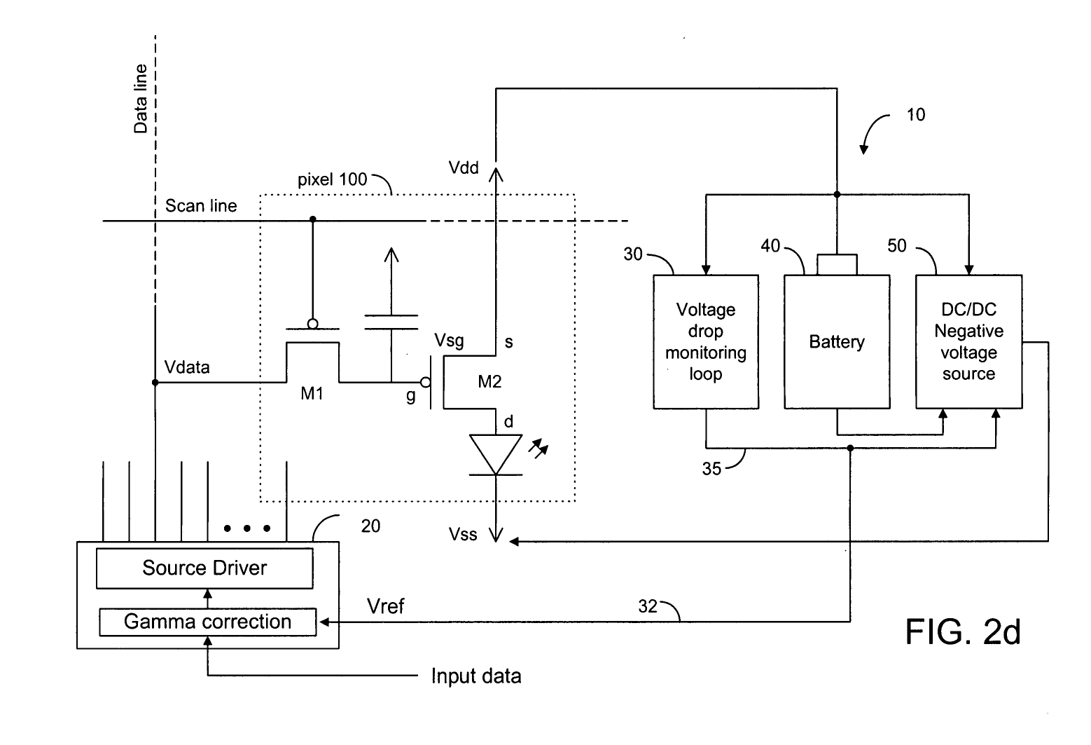

Referring to FIGS. 2a to 2d, the present invention provides a monitoring device 30 in a power supply circuit 10 to monitor the voltage drop in the battery 40. Based on a pre-determined relationship between the gamma control range and a given voltage swing in the data line signal, the monitory device 30 provides a reference voltage level 32 (Vref) to the DATA ASIC 20 so as to allow the DATA ASIC to adjust the voltage level of the data line signal, Vdata. The DATA ASIC comprises a gamma correction module for adjusting the input data based on Vref, so as to allow a source driver to provide the adjusted voltage level of Vdata. Furthermore, the monitoring device 30 provides a reference voltage level 35 to the DC/DC converter 50 so as to allow the DC/DC converter to adjust the Vss voltage level based on the voltage drop in the battery 40. The adjustment of Vss is such that the voltage difference between Vdd and Vss is sufficient to maintain the operation of the driving TFT M2 in the pixel 100 in the saturation region. In FIG. 2a, the driving TFT M2 is a pMOS device while the switching TFT M1 is an nMOS device. In FIG. 2b, the driving TFT M2 is an nMOS device while the switching TFT M1 is a pMOS device. In FIG. 2c, both the driving TFT M2 and the switching TFT M1 are nMOS devices as the OLED panel is made in a full-n process. In FIG. 2d, both the driving TFT M2 and the switching TFT M1 are pMOS devices as the OLED panel is made in a full-p process. It should be appreciated by a person skilled in the art that the arrangement of the switching and driving devices in an AMOLED panel can be made differently, and each of the driving and switching devices can be made in an nMOS or pMOS process. Regardless of what process is used to make the light emitting display panel, the main objective of the present invention is to adjust the brightness of the display panel to a certain extent even when the voltage of the battery decreases with time.

It is possible to design a DATA ASIC that provides data line signals within a fixed voltage swing range based on a reference voltage signal, Vref. For example, with a fixed voltage swing of 2.0 v, the data line signals are in the range between 3.2 v and 1.2 v when the reference signal is 1.2 v. When the reference signal is reduced to 1.0 v, the date line signals are in the range between 3.0 v and 1.0 v. Thus, while the voltage range of the data line signals varies with the reference voltage signal, the voltage swing remains the same. This voltage swing also defines the operation range of the gamma curve. In order to substantially maintain the operation range of the gamma curve in response to the voltage drop of the battery, it is desirable to change the reference voltage Vref to the DATA ASIC.

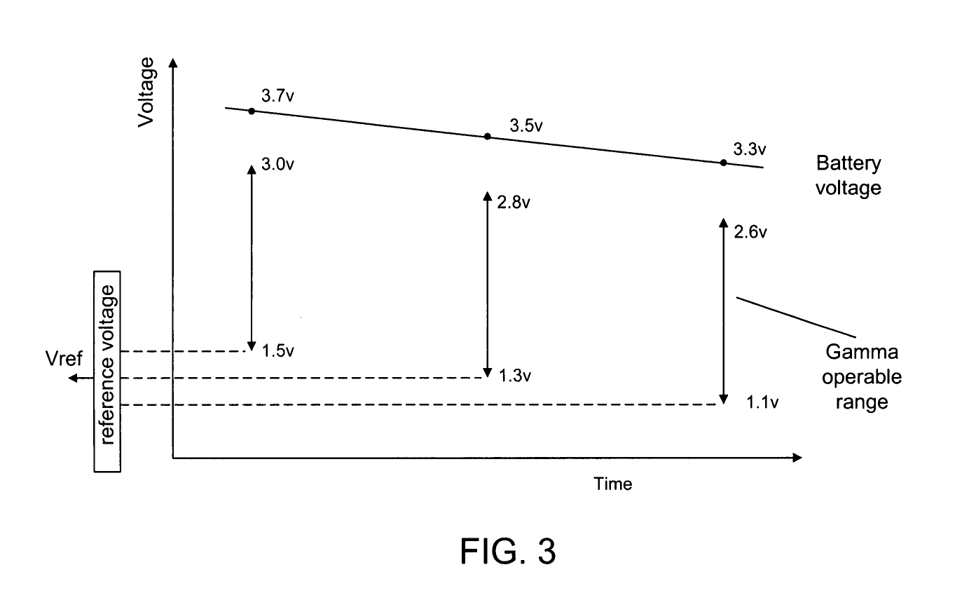

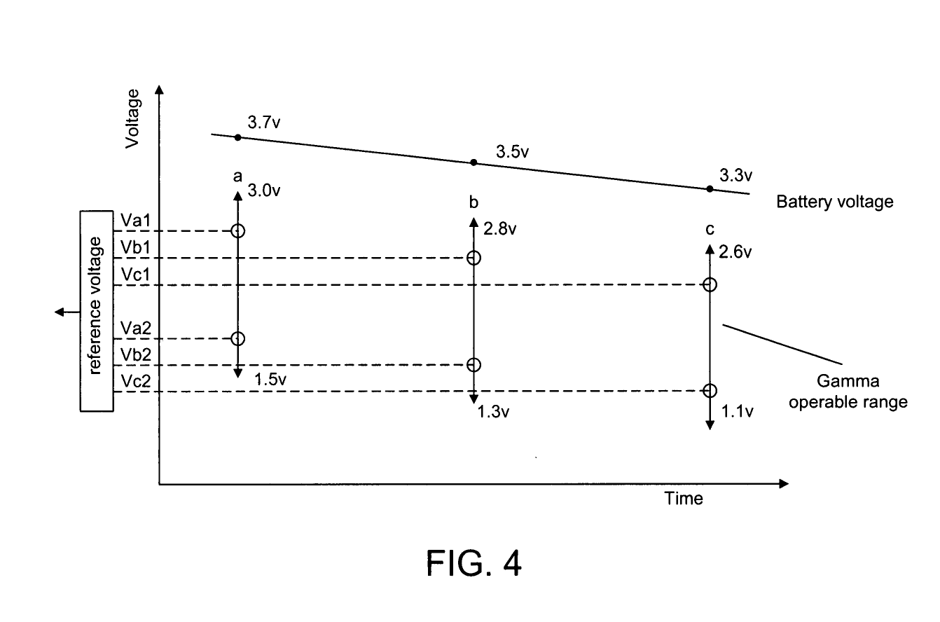

The relationship between the operable range of the gamma curve and the battery voltage is illustrated in FIG. 3. As shown in FIG. 3, the voltage on the battery decreases with time. That would affect the brightness of the displayed image. Assuming that the operable range of the gamma curve varies with battery voltage, we can use the minimum voltage of the gamma operable range as the reference voltage Vref to the DATA ASIC 20 (see FIG. 2). However, it is also possible to use the voltage values in different sections of the gamma operable range, as shown in FIG. 4, to compute the reference voltage Vref to the DATA ASIC 20. As shown in FIG. 4, the voltage values (Va1, Va2), (Vb1, Vb2) . . . at two sections of the gamma operable range are used. The desirable operable range of the gamma curve can be experimentally determined or theoretically derived. Once the relationship between the gamma operable range and the battery voltage is determined, it is possible to relate the reference voltage Vref to the monitored battery voltage or Vdd. For example, it is possible to compute Vref as follows:
Vref=Vdd−2.2 v
Accordingly, the data swing provided by the DATA ASIC is between Vref to (Vref+2.0 v), for example.

At the same time, the DC/DC converter adjusts the voltage level for Vss based on the monitored Vdd so that the driving TFT operates in the saturation region. For example, when Vdd drops from 3.3 v to 3.1 v, Vss can be adjusted from −9.0 v to −9.2 v.

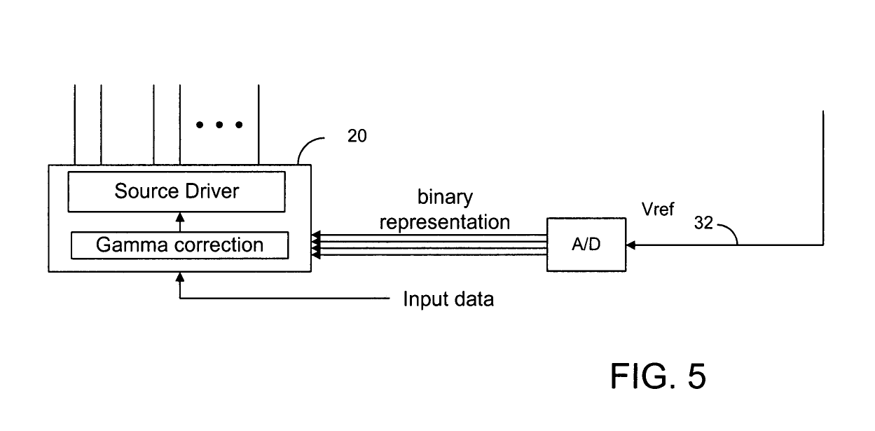

Furthermore, it is possible to use a binary representation of Vref to indicate the changes in the gamma curve or the drop in the battery voltage and provide the binary representation to the DATA ASIC. For example, when the minimum voltage of the gamma operable range reaches 0.4 v, the binary representation is 0101, and when the minimum voltage reaches 0.3 v, the binary representation is 0011. The binary representation can be obtained by using a voltage conversion device such as an analog-to-digital converter, as shown in FIG. 5.

In sum, the present invention uses a monitoring device to determine the voltage of the battery as time goes on and to compute a reference voltage provided to the DATA ASIC so as to allow the DATA ASIC to adjust the data line signals while maintaining substantially the same data voltage swing. At the same time, Vss is adjusted based on the monitored Vdd voltage level so as to maintain a desired operational voltage potential on the driving TFT.

As shown in FIG. 3, the gamma curve has an operable range between 3.0 v and 1.5 v when the battery voltage is 3.7 v. When the battery voltage drops 0.2 v to 3.5 v, the gamma curve can be down-shifted by 0.2 v so that its range is between 2.8 v and 1.3 v. If we divide the gamma curve into four equal segments marked by five gamma points: g1, g2, g3, g4 and g5, with
g1=battery voltage−0.7 v,
g2=battery voltage−1.075 v,
g3=battery voltage−1.45 v,
g4=battery voltage−1.825 v,
and
g5=battery voltage−2.2 v,
then each gamma point is down-shifted by an amount equal to the decrease in the battery voltage. For example, when the battery voltage is equal to 3.7 v, we have g1=3.0 v, g2=2.625 v, g3=2.250 v, g4=1.875 v and g5=1.5 v. When the battery voltage is decreased by 0.2 v to 3.5 v, we have g1=2.8 v, g2=2.425 v, g3=2.05 v, g4=1.675 v and g5=1.3 v. The down-shifted amount for each gamma point is the same.

However, it is possible to adjust each gamma point separately so that some of the gamma points do not down-shifted by an amount equal to the decrease in the battery voltage. For example, when the battery voltage is decreased to 3.5 v, it is possible to have g5=1.3 v, g4=1.7 v, g3=2.1 v, . . . This multi-point gamma curve adjustment may be based on the output characteristics of the OLED and the I-V characteristics of the driving TFT. The multi-point gamma curve adjustment may yield a better gray scale as a function of the battery voltage.

Thus, although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A method to improve viewing quality of a light emitting display having a plurality of pixels, each pixel having at least one light emitting element driven by a current source to produce light, wherein a power source is used to apply a voltage to the current source for driving the light emitting element, and wherein the brightness of the light emitting element driven by the current source is based at least partly on an input signal level provided to the current source and the voltage applied to the current source, said method comprising the steps of:
monitoring a change in the voltage applied to the current source for providing a further signal indicative to the voltage change; and
adjusting, in response to the further signal, the input signal level provided to the current source based on the voltage change so as to reduce a change in the brightness due to the voltage change.

2. The method of claim 1, wherein the power source comprises a battery and the voltage applied to the current source decreases with time, and wherein said adjusting step increases the input signal level provided to the current source for reducing the change in the brightness due to the decrease of the applied voltage.

3. The method of claim 2, wherein the light emitting element comprises an organic light-emitting diode and the current source comprises a thin-film transistor.

4. The method of claim 1, wherein the brightness of the light-emitting element has a relationship with the input signal level and the relationship is based on a level of the applied voltage, and the further signal is also indicative of the level of the applied voltage, and wherein the input signal level in said adjusting step is adjusted based on the relationship.

5. The method of claim 4, wherein the relationship is a gamma curve for the light-emitting element.

6. A driving system for driving a light emitting display having a plurality of pixels, each pixel having at least one light emitting element driven by a current source to produce light, wherein a power source is used to apply a voltage to the current source for driving the light emitting element, and wherein the brightness of the light emitting element driven by the current source is based at least partly on an input signal level provided to the current source and the voltage applied to the current source, said driving system comprising:
a data driver having a plurality of data lines for providing the input signal level to said pixel based on an input data;
a device, operatively connected the power source, for monitoring a change in the voltage applied to the current source for providing a further signal indicative to the voltage change; and
a correction module, in response to the further signal and the input data, for adjusting the input data based on the voltage change so as to allow the data driver to provide an adjusted input signal level to said pixel based on the adjusted input data.

7. The driving system of claim 6, wherein the power source comprises a battery and the voltage applied to the current source decreases with time, and wherein the brightness of the light emitting element is reduced with time due to the decrease in the applied voltage and the adjusted input signal level to the pixel is increased to compensate for the brightness reduction.

8. The driving system of claim 6, wherein the light emitting element comprises an organic light-emitting diode and the current source comprises a thin-film transistor.

9. The driving system of claim 6, wherein the light emitting element comprises an organic light-emitting diode and the current source comprises a pMOS driver.

10. The driving system of claim 6, wherein the light emitting element comprises an organic light-emitting diode and the current source comprises an nMOS driver.

11. The driving system of claim 6, wherein the brightness of the light-emitting element has a relationship with the input signal level and the relationship is based on a level of the applied voltage, and the further signal is also indicative of the level of the applied voltage, and wherein the input signal level is adjusted based on the relationship in the correction module.

12. The driving system of claim 11, wherein the relationship is a gamma curve for the light-emitting element.

13. An active matrix display device for use with a power source, said display device comprising:
a plurality of pixels, each of the pixels having at least one light emitting element driven by a current source to produce light, wherein the power source is used to apply a voltage to the current source for driving the light emitting element;
a data driver having a plurality of data lines for providing an input signal level to said pixel based on an input data, wherein the brightness of the light emitting element driven by the current source is based at least partly on an input signal level provided to the current source and the voltage applied to the current source;
a monitoring module, operatively connected the power source, for monitoring a change in the voltage applied to the current source for providing a further signal indicative to the voltage change; and
a correction module, in response to the further signal and the input data, for adjusting the input data based on the voltage change so as to allow the data driver to provide an adjusted input signal level to said pixel based on the adjusted input data.

14. The display device of claim 13, wherein the light emitting element comprises an organic light-emitting diode and the current source comprises a thin-film transistor.

15. The display device of claim 13, wherein the light emitting element comprises an organic light-emitting diode and the current source comprises a pMOS driver.

16. The display device of claim 13, wherein the light emitting element comprises an organic light-emitting diode and the current source comprises an nMOS driver.

17. The display device of claim 14, wherein each pixel comprises a switching device operatively connected to a data line to provide the input signal level to the thin-film transistor.

18. The display device of claim 17, wherein the switching device comprises a pMOS device.

19. The display device of claim 17, wherein the switching device comprises an nMOS device.
